(19) United States
(12) Patent Application Publication
(10) Pub. No.: US 2009/0135689 A1
(43) Pub. Date: May 28, 2009

(54) ERROR RECOVERY STRATEGY FOR BLU-RAY DISCS

(75) Inventors: Willem Van Der Brug, Eindhoven (NL); Xander Hover, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,877

(22) PCT Filed: Oct. 18, 2005
(86) PCT No.: PCT/IB05/53409

§ 371 Date: Apr. 25, 2007

(30) Foreign Application Priority Data
Oct. 25, 2004 (EP) 04105273.9

(51) Int. Cl. G11B 20/10

(52) U.S. Cl. 369/47.14; G9B/20.009

(57) ABSTRACT

The invention relates to an optical recording device utilizing an error recovery strategy method which may be implemented in software code. The error recovery method comprise steps of stopping writing data to an extent upon detection of an error and writing the rest of the extent to another location in a data file on the disc (1). After all extents have been written, a repair process repairs the faulty extent by combining the first faulty extent and the last part written to another location in a data file. The combined extent is an error free continuous extent.

### FIELD OF THE INVENTION

The present invention relates to bit detection in an optical disc player, and specifically to an error recovery strategy on a high-density optical disc equipped with a fragmented data storage method.

### BACKGROUND OF THE INVENTION

Currently there is extensive on going research on data storage systems such as optical discs, e.g. CD (compact disc), DVD (digital video disc), and BD (Blu-Ray disc) systems, in order to keep up with the ever increasing demand for data storage capacity from users of data systems. Blu-Ray discs utilize a similar technology as for the conventional CD systems; however, the laser used is a laser in the blue-violet range (often at 405 nm, however other wavelengths may be considered). Another significant difference between Blu-ray Disc and CD/DVD is that data can be stored fragmented into extents. Details on how BD systems operate according to the standard specification may be found elsewhere.

Some of the current research and development within the BD technical field involves the possibility to increase the data storage capacity of the Blu-Ray discs above the standard specification of 27 GB. Different technologies are utilized in this process such as double layers and/or higher density of data bits stored on these discs. Unfortunately, increasing the density of bits increases the probability for read and/or write errors. Therefore different attempts to overcome this problem have been presented in the literature.

In order to reduce the amount of errors during recording and playback, a recorder is required to have a significant local storage capability. This ensures that errors may be recovered and that the allocation rules may be complied to. However, having large local storage. available in the recorder increases the complexity and cost of the device.

WO03096338 teaches about a device for recording digitally encoded video information. The device has an error detection unit for detecting recording errors and a bridging unit for creating a bridge segment in the event of a detected recording error. The bridge segment replaces the recorded information between an exit point in a segment before the detected recoding error and an entry point in a segment after the recording error. The final recording contains a series of data blocks and bridge clips from faulty blocks to non faulty blocks. This does not repair the damaged portion but creates a smooth transition bridging the faulty part. Unfortunately there are some other problems concerning this solution, namely the requirement to have a significant amount of local storage or to handle problems with maintaining compatibility with systems not conforming to this solution.

### SUMMARY OF THE INVENTION

Accordingly, the invention preferably seeks to mitigate, alleviate or eliminate one or more of the above-mentioned disadvantages singly or in any combination.

The present invention overcomes the above-identified deficiencies in the art and solves at least the above-identified problems by providing a device, a method, and a computer program that implements an error recovery method, according to the appended patent claims.

The general solution according to the invention is to during the recording phase when an error is detected to stop writing data to an extent, keep the allocation of the extent and write the remaining data to another location on the disc in a data file. After all data has been written a repair process repairs the faulty extents by combining the first faulty extent with the remaining part from the data file into a full repaired extent.

According to one aspect of the invention, a method is provided, for recording data to an optical disc, using a fragmented file system, wherein the method comprise the steps of:

preallocating an original first extent on a disc;

writing data to said original first extent;

stopping writing said data upon detection of an error; continuing writing data not yet written of said original first extent to another location on said disc in a data file; and

combining, in a repair process, said original first extent with said data file to a continuous repaired extent at a later time, e.g. after all original extents have been written.

According to yet another aspect of the invention, a device for recording data to an optical disc is provided. The apparatus is adapted to include:

an arrangement or instruction set for writing data to an extent of a disc;

an arrangement or instruction set for stopping writing said data to said extent upon detection of an error;

an arrangement or instruction set for keeping the allocation of said written data into a first extent;

an arrangement or instruction set for continuing writing data of said extent to another location on said disc in a data file;

an arrangement or instruction set for combining in a repair process said first extent with said data file to a continuous repaired extent at a later time, e.g. after all original extents have been written.

In yet another aspect of the present invention an optical reading device is provided. The optical reading device may use the error recovery information not yet used for repairing faulty extents (written using the above mentioned method according to the invention), for reading and correcting for errors during the reading phase. This may be done each time a disc is read as opposed to the above repairing process that may be done once and there after the disc is irreversibly repaired and essentially error free.

The present invention has the advantage over the prior art that it is fully compatible with optical readers not implementing the present invention, and the present invention reduces the amount of local storage necessary in a optical recording device. It is also possible to resume the repair process at a later time and in fact even in a different device as long as the device implements the method according to the present invention.

These and other aspects of the invention will be apparent from and elucidated with reference to the embodiments described hereinafter.

### BRIEF DESCRIPTION OF THE DRAWINGS

In the following, the invention will be described in a non-limiting way and in more detail with reference to exemplary embodiments illustrated in the enclosed drawings, in which:

FIG. 1 is a schematic block diagram illustrating an optical recording system according to the present invention;

FIG. 2 is a schematic block diagram of a method according to the present invention; and

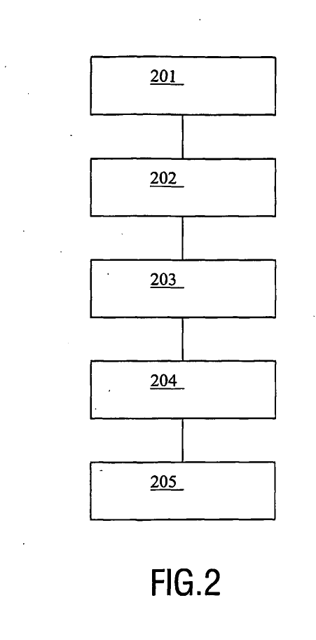

FIG. 3 is a schematic block diagram of a device according to the present invention.

### DETAILED DESCRIPTION OF THE INVENTION

The present invention provides a locking aid method used in optical recording systems utilizing a fragmented recording strategy, such as Blu-Ray discs systems or devices. Data is stored on a Blu-Ray disc in a fragmented manner and may be randomly accessed as opposed to conventional CD (compact disc) or DVD (digital video disc) wherein data is stored in a consecutive manner and accessed sequentially as stored on the discs.

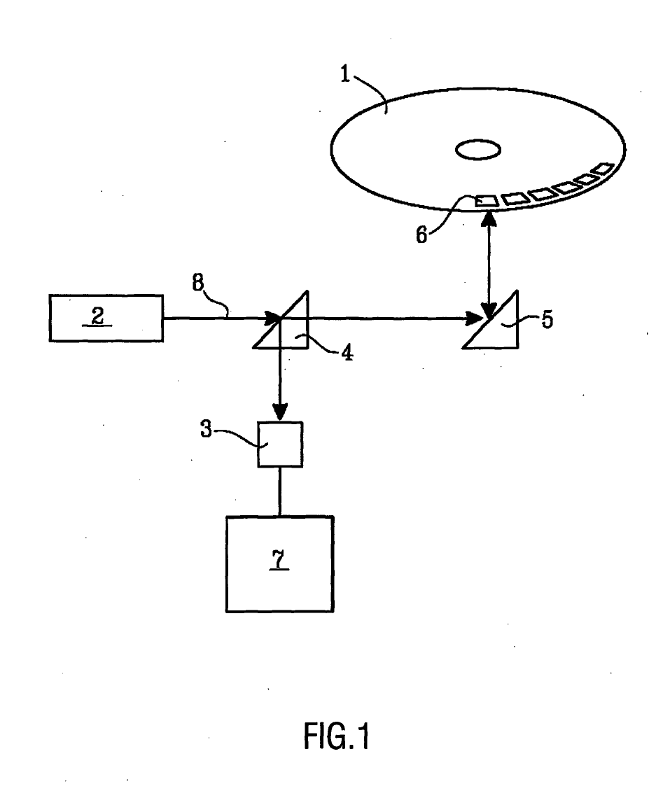

FIG. 1 illustrates a system for reading and writing data to/from an optical disc using an optical source, e.g. a laser, e.g. in the form of a laser diode, with a laser wavelength of 405 nm, for reading and writing the data. The invention is not limited to the above mentioned laser wavelength; however, this wavelength is used in the best mode of the present invention. A disc 1 is used for storing data and a laser source 2 produces a light beam 8 directed onto the disc 1. The optical beam 8 may pass through several optical components 4, 5, the number of components depends on the specific solution used. The optical beam 8 is reflected from the disc 1 and is transferred to a detector 3 which in turn is connected to a processing unit 7 for signal analysis and depending on appliance; the data is presented in different ways. For instance, for a music player music is outputted to either an amplifier or directly to a speaker (not shown), for a video player, a video signal is outputted to a television set, or in the case of a data reader data bits are outputted to for instance a personal computer (PC).

The optical beam 8 is subject to different optical components such as at least one focusing lens, one or several actuating optical components for moving the optical beam to different positions on the disc 1, and a detector for detecting 3 reflected radiation indicative of data recorded on the disc. In some solutions several of these functions may be incorporated into a reading head that may be movable with respect to the radial direction of the disc 1.

The present invention relates to a method used during a recording phase, where data is recorded onto a disc 1. Data is recorded onto a disc 1 in information blocks 6. Sometimes such an information block is called an extent. An extent is defined as an area where a certain data packet is stored. Data is represented on the disc as grooves, pits, or bumps in a recording layer often protected by some protective layer. The key feature of this recording layer is that data is represented as reflectivity changes in the recording layer.

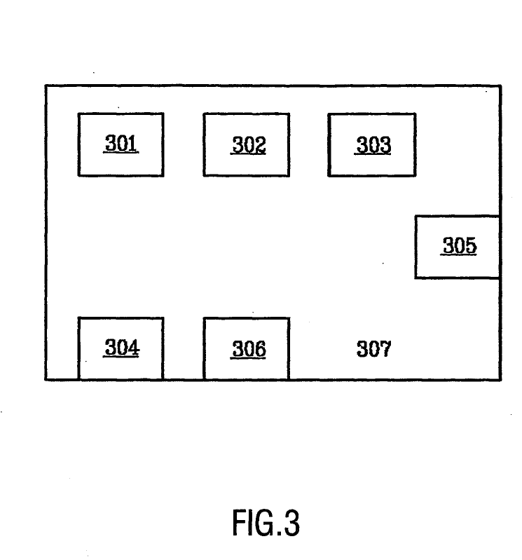

Data is measured by a detector 3 and a thus provided data signal is processed by a processing unit 301 as seen in FIG. 3. The processing unit may comprise e.g. a demodulator, deformatter, and error detection means. Other functions may be provided by the processing unit 301, such as control mechanisms for controlling the reading process and location of radiated optical beam, reading speed, or other steering mechanisms. The processing unit 301 may be part of a disc reading device 307 comprising e.g. the processing unit 301, memory unit 302, output means 304, input means 305, connectivity means 306, and other functionality means 303.

The processing unit 301 may be a microprocessor, a DSP (digital signal processor), an ASIC (Application Specific Integrated Circuit), an FPGA (field programmable gate array), or similar computational unit.

The memory unit 302 may comprise either a volatile memory such as, but not limited to, a RAM chip, or a non-volatile memory such as, but not limited to, rewritable ROM, hard disc, flash memory, or other commonly available memory solutions.

Output means or arrangement 304 may be used for outputting a read signal to an external device for further processing or for end user usage. Signals may outputted to, for instance, a computer for transferring data, to a music or video playback system, or they may be outputted directly to a viewing or listening device such as a television set or headphones.

Input means or arrangement 305 may be used for human or device interaction with the disc reading device. Humans may want to control the disc reading device directly using buttons located on the device or through a remote control device for starting, stopping, or similar operative functioning control. Connectivity means 306 may be used for acquiring signals from the disc reading components (optical components, detector and so on). Other communication means (not shown) may be used for communicating with the device using serial link, parallel link, or network functionality, such as Ethernet or similar packet based communication protocols, wired or wireless.

Data is recorded/stored on a disc in extents, i.e. a chunk of contiguous disk space of a certain size. Depending on type of data the size of extents will vary, for example, but not limited to, 12 Mbytes for a transport stream and 24 Mbyte for a DV stream.

A reading device is often equipped with some error detection means that maybe incorporated in the processing unit or in a separate functional unit. The error detection means is used for detecting errors due to errors originating during the recording phase, from wear and damages on the disc, or from vibrations or other mechanical disturbances influencing the device during playback. Depending on the error source different solutions are implemented. The present invention relates to errors originating during the recording phase and attempts to remedy these problems during that phase.

In a preferred embodiment of the present invention a method for error recovery is implemented and will now be discussed. During the recording phase errors may occur and if they are detected the present invention has a novel method of responding to recording errors and strategy for recovery of damaged data. When an error is detected during the recording phase, the control system suspends the writing of the data to that extent (let us call this extent the first extent) and the unwritten part of the first extent is written to another location of the disc in a data file, while at the same time keeping the allocation of the original extent. In the data file created for this “unwritten” part of the extent (let us call this the second extent), a record used for repairing the damaged extent at a later stage is incorporated. After this, the process continues to write the next extent to the disc. The second extent may be of different size than the original extent since it is written to a data file not used for the actual playback/reading of the information stored on the disc, but only used for a repair process.

After the end of the recording phase, a background process is started that repairs the damaged extent or extents by rewriting each into a respective continuous extent instead of keeping the information split at different locations. The repair process combines the first and second extent into one extent comprising the full information of the original extent that was interrupted due to an error.

Let us take a closer look by examining an example: Assume that an extent needs to be at least 24 Mbyte long and that during the write process an error occur after 10 Mbyte has been written. Then the write process is suspended and the remaining 14 Mbyte is written to a data file at another location on the disc, as opposed to the prior art systems where the entire 24 Mbyte extent need to be rewritten at another location. In the prior art a “bridge” is created in order for the disc reading device to jump to the new location in order to have a continuous reading of data, which is essential for streaming applications such as video or music discs. In the present invention the repair process can rewrite the extent to the same location as first was attempted to write to, since the allocation was kept intact and therefore space on the disc was reserved for this purpose. However, the invention is not limited to writing the data to same location as the original faulty attempt, but data may be written to any suitable location on the disc. The data is collected into one extent from the two parts of the original extent (first extent and second extent stored in a data file) and written to the disc. Of course a combination is possible, wherein some repaired extents are written to their respective original locations and some repaired extents are written to other locations. The resulting repaired extent is after the repair process error free.

In a case where a write buffer is starting to be full, the process will start to immediately write the “unwritten” part to a data file instead of retrying to write the extent during the write process. In order to better make use of the disc area it is wise to, during the repair process, at least try to write the faulty extents to the physical location as the original faulty extents were written to. This reduces the amount of disc area used and the extents will come in a more ordered continuous form, increasing the stability of the readout process for some high density applications. If the repair process fail to rewrite the data to the same location as the original extent was written to, it may write to another location, this may indicate that the physical location of the disc is damaged.

If the repair process is interrupted, the error parts will not be readable by a disc reader configured according to prior art; however since all disc reader have one or several different error detection and handling systems, the disc will be readable with the exception of the missing parts, possibly causing glitches in the playback of the information. The standard disc readers normally have functionality for responding to dirt, scratches, or other damages apparent on discs. This means that even though the data is not repaired, the disc is still readable by systems not implementing the present invention.

The method may further comprise the possibility to handle an interruption during the repair phase, e.g. a power down situation, the user removes the disc, or some other process in a device controlling or in communication with the recording device according to the present invention interrupts the repair process. If any such interruption stops the repair process, the method according to the present invention resumes the repair process at a later stage when it is possible: at power up, disc insert or similar. The resuming of the repair process may be started even if the disc containing unrepaired extents is inserted into another disc recording device as long as this new device is implementing the method according to the present invention. This new device will then be able to continue or start with the repair process when the disc is inserted.

The method may be summarized in the following list of steps:

preallocating an original first extent on a disc;

writing data to said original first extent;

stopping writing said data upon detection of an error;

continuing writing data not yet written of said original first extent to another location on said disc in a data file; and

combining, in a repair process, said original first extent with said data file to form a continuous repaired extent at a later time, e.g. after all original extents have been written.

One of the benefits of the present invention is that it is not necessary to maintain a large local storage area in the recorder while at the same time keeping devices implementing the present invention compatible with equipment not implementing the present invention. Also discs recorded using a device according to the present invention will be compatible during playback with devices not implementing the present invention.

The method may be implemented in a disc recording device according to the present invention and may be implemented as software code in a computer program stored in a computer readable medium and executed for instance in the processing unit 301. Such a disc recording device may comprise the following arrangements:

an arrangement for allocating an extent;

an arrangement for writing data to an extent of the optical disc;

an arrangement for stopping writing the data to the extent upon detection of an error;

an arrangement for keeping the allocation of the written data into a first extent;

an arrangement for continuing writing data of the extent to another location on said disc in a data file;

an arrangement for combining in a repair process the first extent with the data file to form a continuous repaired extent at a later time.

A complete system according to the present invention may comprise a disc, mechanical and optical components, control and processing system and output means, wherein the control and processing system comprise error detection and the error recovery according to the present invention.

Yet another embodiment of the present invention is a disc reader that utilizes information provided by the first extent and the data file part to correct for faulty extents when reading the disc. This may be done every time the disc is read and not only once in a repair process.

One advantage of the present invention is that a disc recorder is provided that will operate with considerably less local storage than compared with the current state of the art. This means that it may be produced at considerably less cost, since memory, such as RAM or similar fast volatile memory units, are quite expensive and add significantly to the production cost of the recording devices. Another advantage is that discs recorded with the present invention is, even if they are not repaired yet, compatible with disc readers not implementing the present invention.

Although the invention has been exemplified by embodiments using blu-ray disc, similar embodiments may be utilized for other optical or other storage media utilizing a fragmented recording strategy. CD and DVD recording formats utilize a recording strategy wherein data are stored in a consecutive manner chronologically after each other, whereas a fragmented recording strategy means that data are stored scattered on the media and accessed with a random access method.

It should be appreciated by the person skilled in the art that the terms “extent” and “data file” both refer to information blocks of binary data and may be interchanged with each other and should not be taken as a limitation of the invention, since they have only been used for increasing clarity of the present invention.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

It should be noted that in this document the word “comprising” does not exclude the presence of other elements or steps than those listed and the words “a” or “an” preceding an element do not exclude the presence of a plurality of such elements: Is should further be noted that any reference signs do not limit the scope of the claims, that the invention may be implemented by means of both hardware and software, and that several “means” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

1. A method for writing data to an optical disc (1), utilizing a fragmented recording strategy, said method comprising the steps of:
writing data of an original extent to said optical disc;
stopping writing said data upon detection of an error;
keeping the allocation of said written data into a first extent;
continuing writing data not yet written of said original extent to another location on said disc in a data file; and
combining, in a repair process, said first extent with said data file to a continuous repaired extent at a later time.

2. The method according to claim 1, wherein said combining in a repair process is performed when all original extents have been written.

3. The method according to claim 1, further comprising the steps of:
continuing said repair process at another time if said repair process is interrupted.

4. The method according to claim 3, wherein said interruption of said repair process may be from a power failure or a removal of said disc (1).

5. The method according to claim 1, wherein said combining in a repair process comprise writing to the same location as said first extent;

6. The method according to claim 1, wherein said combining in a repair process comprise writing to a location different from said first extent;

7. The method according to claim 1, wherein said data file contain a record comprising information used for repairing the recording at a later time.

8. The method according to claim 7, wherein said record comprises address information about said first extent.

9. The method according to claim 1, wherein said optical disc is a blu-ray disc (BD).

10. The method according to claim 1, wherein said repair process is operated as a background process.

11. The method according to claim 1, further comprising the step of:
continuing said repair process if said error occurred in another device.

12. A device for writing data to an optical disc utilizing a fragmented recording strategy, comprising:
an arrangement for writing data to an extent of said optical disc;
an arrangement for stopping writing the data to said extent upon detection of an error;
an arrangement for keeping the allocation of said written data into a first extent;
an arrangement for continuing writing data of said extent to another location on said disc in a data file;
an arrangement for combining in a repair process said first extent with said data file to a continuous repaired extent at a later time.

13. The device according to claim 12, further comprising:
an arrangement for continuing the repairing process of said error at another time if said repair process is interrupted.

14. The device according to claim 12, wherein said arrangement for combining in a repair process comprise means for writing to said allocated extent;

15. The device according to claim 12, wherein said arrangement for combining in a repair process comprise an arrangement for writing to another extent;

16. The device according to claim 12, wherein said data file contain a record comprising information used for repairing the recording at a later time.

17. The device according to claim 16, wherein said record comprises address information about said first extent.

18. The device according to claim 12, wherein said optical disc is a blu-ray disc (BD).

19. The device according to claim 12, wherein said repair process is operated as a background process.

20. The device according to claim 12, further comprising:
an arrangement for continuing said repair process if said error occurred in another device.

21. A computer program for writing data to an optical disc utilizing a fragmented recording strategy, comprising:
an instruction set for writing data to an extent of said optical disc;
an instruction set for stopping writing said data to said extent upon detection of an error;
an instruction set for keeping the allocation of said written data into a first extent;
an instruction set for continuing writing data of said extent to another location on said disc in a data file;
an instruction set for combining in a repair process said first extent with said data file to a continuous repaired extent at a later time.

22. A device for reading data from an optical disc (1) utilizing a fragmented recording strategy, comprising:
an arrangement for reading data from an extent of said optical disc, wherein said data is recorded with the method according to claim 1 but said repair step has not yet been done; and
an arrangement for combining, in a correction process during said reading phase, said first extent with said data file to a corrected repaired extent.
